(19) United States
(12) Patent Application Publication
(10) Pub. No.: US 2005/0213229 A1
(43) Pub. Date: Sep. 29, 2005

(54) Mirror assembly with damping mechanism

(76) Inventors: Stephen D. Cofer JR., Sugargrove, PA (US); Corey Seymour, Russel, PA (US)

Correspondence Address: The Bilicki Law Firm, P.C., 1285 North Main Street, Jamestown, NY, 14701, US

(21) Appl. No.: 11/093,716

(22) Filed: Mar. 29, 2005

Related U.S. Application Data
(60) Provisional application No. 60/557,277, filed on Mar. 29, 2004.

(51) Int. Cl. G11B 7/00

(52) U.S. Cl. 359/843; 359/871

(57) ABSTRACT

The present invention is a mirror assembly comprised of: a mirror; a mirror carrier adapted to receive the mirror; an actuator functionally engaging the mirror carrier; a mirror support structure with first and second ends, the first end adapted to engage the mirror carrier and the second end either adapted to engage or integral to a mirror support arm; a shell substantially encasing the mirror carrier, the actuator, and the mirror support plate; and at least one mirror mount, in which each mirror mount is positioned within a corresponding recess on a bottom surface of the actuator and a corresponding recess on the first end of the mirror support structure to absorb vibrations and steady the mirror assembly. The mirror mount is comprised of an isolator and one or more bolts extending therefrom and into the actuator and the mirror support recesses. The isolator can further include one or more annular rings.

### CROSS-REFERENCE TO RELATED APPLICATIONS

This application claims the benefit of and priority to U.S. provisional application No. 60/557,277 filed Mar. 29, 2004, incorporated herein in its entirety.

### FIELD OF THE INVENTION

The subject invention relates generally to vehicular mirrors. More particularly, the invention relates to a mirror assembly with a vibration damping mechanism to reduce or eliminate vibrations in the mirror assembly when the vehicle is in operation.

### BRIEF DESCRIPTION OF THE DRAWINGS

FIG. 1 is an exploded perspective view of one embodiment of a mirror assembly.

FIGS. 2a and 2b are side views of two embodiments of the damping mechanism shown in FIG. 1.

### DETAILED DESCRIPTION OF EMBODIMENTS OF THE INVENTION

For the purpose of promoting an understanding of the present invention, references are made in the text hereof to embodiments of a heavy-duty mirror assembly and damping mechanism, only some of which are illustrated in the drawings. It is nevertheless understood that no limitations to the scope of the invention are thereby intended. One of ordinary skill in the art will readily appreciate that modifications such as the shape and materials of the components, the positioning of the components, the types and number of mirrors, or the number of damping mechanisms do not depart from the spirit and scope of the present invention. Moreover, use of the invention is not intended to be limited to heavy-duty vehicles, but could also be used in the light vehicle, off-road, and boating industries, as well as industrial applications. Some of these possible modifications are mentioned in the following description. Furthermore, in the embodiments depicted, like reference numerals refer to identical structural elements in the various drawings.

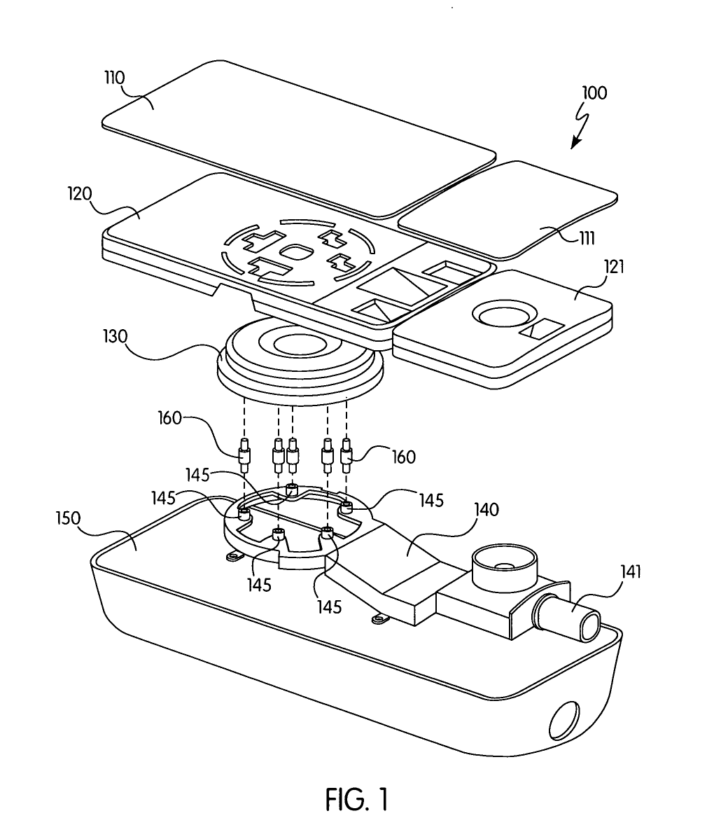

FIG. 1 shows one embodiment of mirror assembly 100 in which flat mirror 110, convex mirror 111, flat mirror carrier 120, convex mirror carrier 121, actuator 130, support structure 140, shell 150, and mirror mounts 160 can all be appreciated. The depiction of mirror assembly 100 as shown in FIG. 1 is only exemplary, and one of ordinary skill will appreciate that mirror assembly 100 need not have two separate mirror pieces, that mirror assembly could be only one piece, more than two pieces, or that multiple convex and/or concave mirrors, as well as combinations thereof, could be used; that mirror assembly need not necessarily include shell 150; and that flat mirror 110, convex mirror 111, flat mirror carrier 120, convex mirror carrier 121, actuator 130, support structure 140, or shell 150 could be of any shape well-known in the heavy-duty vehicle or other industries. In the embodiment shown, mirror carrier 120 and convex mirror carrier 121 are made of an ASA plastic, but could be made of any similarly durable material; actuator 130 is made primarily of acetyl and glass filled nylon; shell 150 is made of ABS plastic, but could also be made of a PCABS plastic blend or ASA plastic; and support structure 140 is made of aluminum or an aluminum alloy. However, one of ordinary skill in the art will realize that these materials are only exemplary and not intended to be limiting.

In the embodiment of mirror assembly 100 shown in FIG. 1, flat mirror 110 is secured to flat mirror carrier 120 by any mechanism well-known in the art, and convex mirror 111 is secured to convex mirror carrier 121, also by any mechanism well-known in the art. Flat mirror carrier 120 and convex mirror carrier 121 are secured to the top surface of actuator 130 which allows mirror assembly 100 to pivot relative to the vehicle to which it is attached. Flat mirror carrier 120 and convex mirror carrier 121 are also secured to shell 150, generally encasing mirror support structure 140 within mirror assembly 100, but without engaging actuator 130 or mirror support plate 140. The various components can be secured to one another by any means, including but not limited to bolts, screws, adhesives, or mechanically fitting the components together, e.g., snap-fitting. End 141 of mirror support structure 140 is adapted to be secured to any mirror support arm (not shown). As shown, support structure 140 is a support plate adapted to receive a mirror support arm. However, the support plate and the arm could be made of one integral unit. It is contemplated that mirror support structure, as used herein, encompass these alternate embodiments.

Actuator 130 is not secured to or directly touching the bottom surface of mirror support structure 140 in any substantial way, i.e., not constraining vertical movement. Rather, actuator 130 and mirror support structure 140 are each secured to opposite ends of each mirror mount 160, the effect of which is that mirror mounts 160 isolate actuator 130, flat mirror 110, and convex mirror 111 from mirror support structure 140 and consequently from vibrations from the vehicle such as engine disturbance (e.g., acceleration, velocity, displacement, or engine roll), road input, air flow, and shock input such as that caused by shutting the vehicle's door.

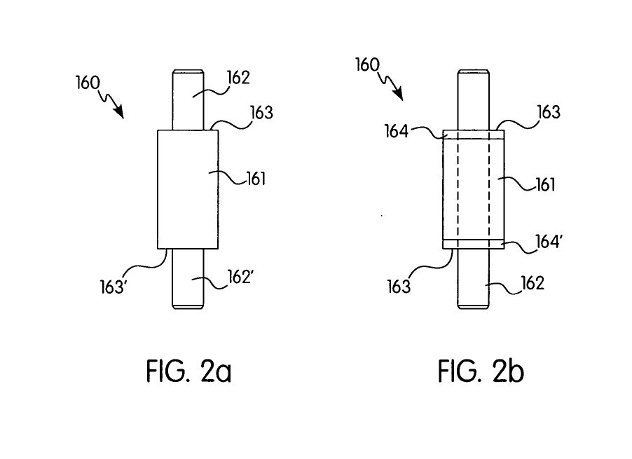

FIGS. 2a and 2b show side views of two embodiments of mirror mount 160 which act as the vibration damping mechanism. Mirror mount 160 is comprised of bolt 162 and isolator 161. Bolt 162 can be two separate elements secured to isolator 161 at surfaces 163 as shown in FIG. 2a, or bolt 162 can penetrate through isolator 161 as shown in FIG. 2b.

In one embodiment, as shown in FIG. 2a, bolt 162 is received by the actuator (not shown), with surface 163 bearing the load of the actuator. Bolt 162′ is received by the mirror support structure (not shown), with surface 163′ bearing the load of the mirror support structure. As vibrations are created by the vehicle to which the mirror assembly (not shown) is attached, mirror mount 160 absorbs the vibrations, minimizing the vibration of the mirror (not shown).

In the alternate embodiment shown in FIG. 2b, bolt 162 is one element, running the length of mirror mount 160 and protruding from both ends. Further included in this second embodiment of mirror mount are generally annular rings 164 and 164′. Rings 164 and 164′ are made of a rigid material and helps bear the load of the actuator (not shown) and the mirror support structure (not shown), to prevent damage to isolator 161. In this embodiment, one end of bolt 162 is received by the actuator, with ring 164 bearing the load of the actuator and the second end of bolt 162 is received by the mirror support structure, with ring 164′ bearing the load of the mirror support structure. As with the embodiment shown in FIG. 2a, vibrations are created by the vehicle to which the mirror assembly (not shown) is attached, and mirror mount 160 absorbs the vibrations, minimizing the vibration of the mirror (not shown). Rings 164, 164′ could also be employed in the embodiment of mirror mount 160 shown in FIG. 2a.

As stated supra, the various embodiments of mirror mount 160 are comprised of isolator 161, bolt 162 or bolts 162, 162′, and annular rings 164, 164′. Isolator 161 is, in the embodiment shown, a natural rubber. Isolator 161 can alternately be made of neoprene, silicone, or any other elastomeric material. Also in the embodiment shown, bolt 162 or bolts 162, 162′ are made of stainless steel, but could also be made of steel. One of ordinary skill in the art, however, will recognize that these materials are only exemplary and are not intended to be limiting.

Referring again to FIG. 1, in the embodiment shown, there are five mirror mounts 160. However, using five mirror mounts 160 is not intended to be limiting. Rather, any number of mirror mounts 160 can be used, depending on the application, the mass of the mirror assembly, and other factors, so long as the mirror assembly is isolated from the mirror support arm (not shown) and the vehicle.

Each mirror mount 160 functionally engages to the bottom surface of actuator 130 on a first end and mirror support plate 140 on a second end. The bottom surface of actuator 130 has five recesses (not visible), each recess corresponding to one mirror mount 160. Similarly, mirror support structure 140 has five recesses 145, each corresponding to one mirror mount. Bolt 162 or 162′ rests within the recesses in the bottom surface of actuator and recesses 145 or mirror support structure 140, with the point of contact between mirror mounts 160 and actuator 130 being surface 163 (for the embodiment of mirror mount 160 shown in FIG. 2a) or ring 164 (for the embodiment of mirror mount 160 shown in FIG. 2b). The point of contact between mirror mount 160 and mirror support structure 140 being surface 163′ (for the embodiment of mirror mount 160 shown in FIG. 2a) or ring 164′ (for the embodiment of mirror mount 160 shown in FIG. 2b). In the embodiment shown, ring 164 is a stainless steel or steel hexagonal nut over-molded with an elastomeric material, but could be any material or configuration that provides similar physical characteristics.

Although, for convenience, the invention has been described primarily with reference to specific embodiments, it will be apparent to those of ordinary skill in the art that the mirror assembly and the components thereof can be modified without departing from the spirit and scope of the invention as claimed.

1. A mirror assembly comprised of:
a mirror;
a mirror carrier adapted to receive said mirror;
an actuator, said actuator comprised of a top surface and a bottom surface, said top surface adapted to functionally engage said mirror carrier and said bottom surface comprised of at least one recess;
a mirror support structure, said mirror support structure comprised of a first end and a second end, said first end comprised of at least one recess; and
at least one mirror mount, each of said at least one mirror mount having a first end and a second end, said first end functionally engaging one of said at least one recess on said bottom surface of said actuator, and said second end functionally engaging one of said at least one recess on said first end of said mirror support structure, wherein each of said at least one mirror mount is adapted to at least partially absorb vibrations and steady said mirror assembly.

2. The mirror assembly of claim 1, wherein said mirror assembly is further comprised of at least one additional mirror, said at least one additional mirror selected from a group comprised of a flat mirror, a concave mirror, and a convex mirror.

3. The mirror assembly of claim 1, wherein said mirror assembly is further comprised of a shell, said shell substantially encasing said mirror carrier, said actuator, and said mirror support plate.

4. The mirror assembly of claim 1, wherein said mirror carrier is made of ASA plastic, said actuator is made of acetyl and glass filled nylon, and said mirror support structure is made of a material selected from a group comprised of aluminum.

5. The mirror assembly of claim 1, wherein said mirror support structure is a mirror support plate adapted to receive a mirror support arm or said mirror support structure is comprised of a mirror support plate and an integral mirror support arm.

6. The mirror assembly of claim 1, wherein each of said at least one mirror mount is comprised of: an isolator, said isolator having a top surface and a bottom surface; a first bolt disposed on said top surface of said isolator and adapted to fit into one of said at least one recess on said bottom surface of said actuator; and a second bolt disposed on said bottom surface of said isolator and adapted to fit into one of said at least one recess of said of said first end of said mirror support structure, said isolator being made of a material selected from a group comprised of natural rubber, neoprene, and silicone, and said first bolt and said second bolt being made of a material selected from a group comprised of steel and stainless steel.

7. The mirror assembly of claim 1, wherein each of said at least one mirror mount is comprised of: an isolator, said isolator having a top surface and a bottom surface and a bore therethrough; and a bolt disposed within said bore, said bolt comprised of a first end and a second end, said first end extending from said top surface of said mirror mount and adapted to fit into one of said at least one recess on said bottom surface of said actuator, and said second end extending from said bottom surface of said mirror mount and adapted to fit into one of said at least one recess of said first end of said mirror support structure, said isolator being made of a material selected from a group comprised of natural rubber, neoprene, and silicone, and said bolt being made of a material selected from a group comprised of steel and stainless steel.

8. The mirror assembly of claim 7, wherein said isolator is further comprised of a first annular ring disposed on said top surface of said isolator and a second annular ring disposed on said bottom surface of said isolator, said first annular ring and said second annular ring being made of a material selected from a group comprised of steel and stainless steel.

9. The mirror assembly of claim 1, wherein each of said at least one mirror mount is generally cylindrical.

10. A device comprised of:
a mirror;
a mirror carrier adapted to receive said mirror;
an actuator, said actuator comprised of a top surface and a bottom surface, said top surface adapted to functionally engage said mirror carrier and said bottom surface comprised of at least one recess;
a mirror support structure, said mirror support structure comprised of a first end and a second end, said first end comprised of at least one recess;
a shell substantially encasing said mirror carrier, said actuator, and said mirror support plate; and
at least one mirror mount, each of said at least one mirror mount having a first end and a second end, said first end functionally engaging one of said at least one recess on said bottom surface of said actuator, and said second end functionally engaging one of said at least one recess on said first end of said mirror support structure, wherein each of said at least one mirror mount is adapted to substantially damp vibrations and steady said mirror assembly.

11. The device of claim 10, wherein said device is further comprised of at least one additional mirror, said at least one additional mirror selected from a group comprised of a flat mirror, a concave mirror, and a convex mirror.

12. The device of claim 10, wherein said mirror carrier is made of ASA plastic, said actuator is made of acetyl and glass filled nylon, said mirror support structure is made of a material selected from a group comprised of aluminum, and said shell is made of a material selected from a group comprised of ABS plastic, a PCABS plastic blend, and ASA plastic.

13. The device of claim 10, wherein said mirror support structure is a mirror support plate adapted to receive a mirror support arm or said mirror support structure is comprised of a mirror support plate and an integral mirror support arm.

14. The device of claim 10, wherein each of said at least one mirror mount is comprised of: an isolator, said isolator having a top surface and a bottom surface; a first bolt disposed on said top surface of said isolator and adapted to fit into one of said at least one recess on said bottom surface of said actuator; and a second bolt disposed on said bottom surface of said isolator and adapted to fit into one of said at least one recess of said of said first end of said mirror support structure, said isolator being made of a material selected from a group comprising natural rubber, neoprene, and silicone, and said first bolt and said second bolt being made of a material selected from a group comprising steel and stainless steel.

15. The device of claim 10, wherein each of said at least one mirror mount is comprised of: an isolator, said isolator having a top surface and a bottom surface and a bore therethrough; and a bolt disposed within said bore, said bolt comprised of a first end and a second end, said first end extending from said top surface of said mirror mount and adapted to fit into one of said at least one recess on said bottom surface of said actuator, and said second end extending from said bottom surface of said mirror mount and adapted to fit into one of said at least one recess of said first end of said mirror support structure, said isolator being made of a material selected from a group comprising natural rubber, neoprene, and silicone, and said bolt being made of a material selected from a group comprising steel and stainless steel.

16. The device of claim 15, wherein said isolator is further comprised of a first annular ring disposed on said top surface of said isolator and a second annular ring disposed on said bottom surface of said isolator, said first annular ring and said second annular ring being made of a material selected from a group comprised of steel and stainless steel.

17. The device of claim 10, wherein each of said at least one mirror mount is generally cylindrical.

18. An assembly comprised of:
a reflective element;
a reflective element carrier adapted to receive said reflective element;
an actuator, said actuator comprised of a top surface and a bottom surface, said top surface adapted to functionally engage said reflective element carrier, and said bottom surface comprised of a plurality of recesses;
a reflective element support structure, said reflective element support structure comprised of a first end and a second end, said first end comprised of a plurality of recesses;
a shell substantially encasing said reflective element carrier, said actuator, and said reflective element support plate; and
a plurality of mirror mounts disposed between said reflective element support structure and said actuator, wherein each of said plurality of mirror mounts isolates said actuator, said reflective element carrier, and said shell from said reflective element support structure and substantially absorbs vibrations, and wherein each of said plurality of mirror mounts has a first end and a second end, said first end functionally engaging one of said plurality of recesses on said bottom surface of said actuator, and said second end functionally engaging one of said plurality of recesses on said first end of said reflective element support structure.

19. The assembly of claim 18, wherein said reflective element is selected from a group comprised of a flat mirror, a concave mirror, a convex mirror, and combinations thereof.

20. The mirror assembly of claim 18, wherein said mirror support structure is a mirror support plate adapted to receive a mirror support arm or said mirror support structure is comprised of a mirror support plate and an integral mirror support arm.

21. The mirror assembly of claim 18, wherein each of said plurality of mirror mounts is comprised of: an isolator, said isolator having a top surface and a bottom surface; a first bolt disposed on said top surface of said isolator and adapted to fit with one of said plurality of recesses on said bottom surface of said actuator; and a second bolt disposed on said bottom surface of said isolator and adapted to fit with one of said plurality of recesses of said of said first end of said reflective element support structure, said isolator being made of a material selected from a group comprised of natural rubber, neoprene, and silicone, and said first bolt and said second bolt being made of a material selected from a group comprised of steel and stainless steel.

22. The mirror assembly of claim 18, wherein each of said plurality of mirror mounts is comprised of: an isolator, said isolator having a top surface, a bottom surface, and a bore therethrough; and a bolt disposed within said bore, said bolt comprised of a first end and a second end, said first end extending beyond said top surface of said mirror mount and adapted to fit within one of said plurality of recesses on said bottom surface of said actuator, and said second end extending from said bottom surface of said mirror mount and adapted to fit within one of said plurality of recesses of said of said first end of said reflective element support structure, said isolator being made of a material selected from a group comprised of natural rubber, neoprene, and silicone, and said bolt being made of a material selected from a group comprised of steel and stainless steel.

23. The mirror assembly of claim 22, wherein said isolator is further comprised of a first annular ring disposed on said top surface of said isolator and a second annular ring disposed on said bottom surface of said isolator, said first annular ring and said second annular ring being made of a material selected from a group comprised of steel and stainless steel.

24. The mirror assembly of claim 18, wherein each of said at least one mirror mount is generally cylindrical.

25. A device for isolating a mirror from vibrational energy imparted from a vehicle comprised of:
at least one mirror mount disposed between a mirror support structure and an actuator, wherein said at least one mirror mount is adapted to isolate said actuator, a mirror carrier, and a mirror from said mirror support structure, and wherein each of said at least one mirror mount is comprised of:
an isolator, said isolator having a top surface and a bottom surface;
at least one bolt extending from said top surface and said bottom surface of said isolator, a first end of said at least one bolt being received within one of at least one recess on a bottom surface of said actuator, and a second end of said at least one bolt being received within one of at least one recess on a top surface of said mirror support structure;
said second end functionally engaging said at least one recess on said second end of said mirror element support structure, wherein each of said at least one mirror mount is adapted to damp vibrations and steady said mirror assembly.

26. The device of claim 25, wherein each of said at least one mirror mount is generally cylindrical.

27. The device of claim 25, wherein said isolator is made of a material selected from a group comprised of natural rubber, neoprene, and silicone.

28. The device of claim 25, wherein said at least one bolt is made of a material selected from a group comprised of steel and stainless steel.

29. The device of claim 25, wherein said isolator is further comprised of a first annular ring disposed on said top surface and a second annular ring disposed on said bottom surface, said first annular ring and said second annular ring being made of a material selected from a group comprised of steel and stainless steel.

30. A mirror sub-assembly, comprised of:
a mirror support structure, said mirror support structure comprised of a first end and a second end, said first end comprised of at least one recess; and
at least one mirror mount positioned between said mirror support structure and an actuator, wherein said at least one mirror mount is adapted to isolate said actuator from said mirror support structure, and wherein each of said at least one mirror mount is comprised of:
an isolator, said isolator having a top surface and a bottom surface;
at least one bolt extending from said top surface and said bottom surface of said isolator, a first end of said at least one bolt being received within one of at least one recess on a bottom surface of said actuator, and a second end of said at least one bolt being received within one of at least one recess on a top surface of said mirror support structure;
wherein each of said at least one mirror mount is adapted to damp vibrations and steady said mirror assembly.

31. The sub-assembly of claim 29, wherein said mirror support structure is a mirror support plate adapted to receive a mirror support arm or said mirror support structure is comprised of a mirror support plate and an integral mirror support arm.

32. The sub-assembly of claim 29, wherein each of said at least one mirror mount is generally cylindrical.

33. The sub-assembly of claim 29, wherein said isolator is made of a material selected from a group comprised of natural rubber, neoprene, and silicone.

34. The sub-assembly of claim 29, wherein said at least one bolt is made of a material selected from a group comprised of steel and stainless steel.

35. The sub-assembly of claim 29, wherein said isolator is further comprised of a first annular ring disposed on said top surface and a second annular ring disposed on said bottom surface, said first annular ring and said second annular ring being made of a material selected from a group comprised of steel and stainless steel.
